(19) United States
(12) Patent Application Publication
(10) Pub. No.: US 2016/0050528 A1
(43) Pub. Date: Feb. 18, 2016

(54) System and method for specified location and nearby area related crime information reporting

(71) Applicant: Todd Alan Kuhlmann, Austin, TX (US)

(72) Inventor: Todd Alan Kuhlmann, Austin, TX (US)

(21) Appl. No.: 14/461,499

(22) Filed: Aug. 18, 2014

(51) Int. Cl. H04W 4/02; H04M 1/725; G06F 17/30

(52) U.S. Cl. CPC H04W 4/023; G06F 17/30241; H04M 1/72572

(57) ABSTRACT

A system and method for reporting of the specific location and nearby area related crime using a communication network includes a wireless user display device communicating over the network with a server and the server communicating with a crime database over a wired or wireless communication network. The method includes selecting geographic location and nearby area of interest on the wireless user display device and then requesting the server for the crime information of the selected location and nearby area. The server then communicates with the crime database and request for the selected property and nearby area specific crime information. The crime database extracts the requested information and transmits the generated report back to server which further processes the received information for generating wireless user display device ready report format which further enables the user to save, edit and share the generated information over the wireless communication network with other users.

### FIELD OF THE INVENTION

The present invention relates generally to an information system, and more particularly to a system and method for specified location and nearby area related crime information reporting.

### BACKGROUND OF THE INVENTION

Almost every country around the world keeps records of the crimes happening in their country and then further splits the data into state, cities and streets. The purpose of this data is to keep an eye out for the crime prone areas and to keep the civilians away from such areas along with keeping required forces at the right place as per the crime rate of that area. Another advantage of such information is to keep residents, travelers and police personals updated so that they can take required precautions while travelling through or around such crime prone area. Wireless communication devices have made availability of such information quick and easy to read. The wireless communication devices comprises a global positioning system and other navigation system to provide specific location related information in the form of maps which is further augmented by indicating the user's current location as determined by the GPS system of the wireless communication device. The system then can be further used for extracting other related information of the user's interest, such as but not limited to Point of interest, restaurants, schools, petrol station, road, traffic data and weather conditions so that the user can make a decision for best suited route or residence location. The user also needs other important information while passing through or selecting a residential location at an unknown area which includes information related to crime rate and safety of the current location.

There is a need to obtain up-to-date crime mapping data to be available to a remote user for indicating the crime rate and safety of current location of the user. Crime reports are prepared for user's current location as reported by the global positioning system of the user's wireless communication device. The crime related information is generally extracted by using wired or wireless communication with multiple crime record databases maintained by the FBI, the U.S. Justice Department and from over 17,000 local law enforcement agencies in the US. Traditionally, the wireless user devices request national databases which then associate crime occurrences from all of these law enforcement agencies to the user location or location the user designates through wireless communication devices.

Crime data is the primary type of data used in crime analysis which is dependent on the crime databases maintained by the FBI, the U.S. Justice Department and from over 17,000 local law enforcement agencies in the US which is captured by police agencies dynamically and is not static. There are many disadvantages using these databases that can lead to misinterpretation or misuse of statistics. The information about crime incidents are constantly being updated which means that the data surrounding crime incidents is also constantly changing. The dynamic nature of crime data creates crime analysis of the location of interest difficult. There are many other unconventional methods of collecting crime related data to provide a better crime analysis and reporting. These unconventional methods includes talk to neighbors, take note if there are bars on the windows and doors of homes, talk to the police or sheriff's department and to check for gang graffiti on walls and walkways which is again difficult to manage and analyze for providing location related crime report to the user. These methods may not provide information for all of the crimes committed in the area and when they were committed. There are resources to access crime databases using computers, but there is a need to obtain crime information using a mobile device while the user is in a specific location or wanting to search a specific location. The crime related information is not readily available and access to information is also difficult as one has to access many databases and may have to request local administration or government representatives for getting access to these databases. This process of collecting crime related information on location of interest is slow and time consuming.

With instant access to crime maps on a mobile device, the important decisions related to user's safety can be made instantly, even while the user is in the field including at a remote location, many smartphone applications are easily available today in which location-dependent data can be requested and displayed in an easy to read user friendly interface. The above mentioned Smartphone applications, such as but not limited to, weather monitoring, meter reading, evaluation of traffic condition requires a large amount of data to be collected from geographically dispersed locations. It is very expensive and labor intensive work to install and maintain the systems for identification and transmission of the location specific or area specific crime data.

Thus there is a need of a system and method that can identify location specific crime information from the already maintained available knowledge databases of the local administration and national government databases and to present the requested information on the user's wireless display devices in an easy to read format.

### SUMMARY OF THE INVENTION

To solve the problems described above, the present invention provides the following solutions.

In a preferred embodiment of the present invention there is provided a system and method for reporting the specified location and nearby area related crime information comprising a user display device which enables the user to request crime information and to view the requested information on the user display device.

In another embodiment of the present invention, the system further includes a webservice request created by the user display device comprising a user access verification data to validate user's access to a server. The server receives the user's current location and location specific request from the wireless user display device in the form of the webservice request. Once the user access is validated by the server, the server then sends specified location and nearby area related crime information request to a crime information database which is in wired or wireless communication network with the server. The property and nearby area related crime information database sends back the requested location specific crime information to the server.

In another embodiment of the present invention, the user location is determined by a location reporting means such as but not limited to a global positioning system (GPS) of the user's display device.

In a further embodiment of the present invention, the specified location and nearby area related crime information data relates to Uniform Crime Reports by the Federal Bureau of Investigation (FBI) and by annual National Crime Victimization Surveys by the Bureau of Justice Statistics.

In a preferred embodiment of the present invention, the specified location and nearby area related crime information database includes database that has been created and compiled by other sources, such as but not limited to, the FBI and the U.S. Justice Department and are from over 17,000 local law enforcement agencies in the US.

In another embodiment of the present invention, the server converts received specified location and nearby area related crime information from the crime information database into the wireless user display device readable format.

In another embodiment of the present invention, the user display device presents the transmitted information in an easy to read format, such as but not limited to, maps, graphs or the like.

In further embodiment of the present invention, the user can share, print, upload or email the specified location and nearby area related crime information to other users using the wireless communication among the user devices.

Further features and advantages of the present invention, as well as the structure and operation of various embodiments of the present invention, are described in detail below with reference to the accompanying drawings.

### BRIEF DESCRIPTION OF THE DRAWINGS

For the purpose of illustration, there are shown in the drawings certain embodiments of the present invention wherein like reference numbers generally indicate identical, functionally similar, and/or structurally similar elements. It should be understood that the invention is not limited to the precise arrangements, dimensions, and instruments shown.

FIG. 1 depicts specified location and nearby area related crime information reporting system according to an exemplary embodiment of the present invention;

FIG. 2 depicts a method of specified location and nearby area related crime information reporting system according to an exemplary embodiment of the present invention;

FIG. 3 depicts an exemplary embodiment of a user display device according to an exemplary embodiment of the present invention;

FIG. 4 depicts another exemplary embodiment of a user display device illustrating an input keypad and a search box; and

FIG. 5 depicts an exemplary embodiment of a user display device illustrating specified location and nearby area related crime information report according to an exemplary embodiment of the present invention.

### DETAILED DESCRIPTION OF THE INVENTION

In this section, some preferred embodiments of the present invention are described in detail sufficient for one skilled in the art to practice the present invention. It is to be understood, however, that the fact that a limited number of preferred embodiments are described herein does not in any way limit the scope of the present invention as set forth in the appended claims. It is also to be understood that a person skilled in the relevant art will recognize that other components and configurations can be used without parting from the spirit and scope of the invention.

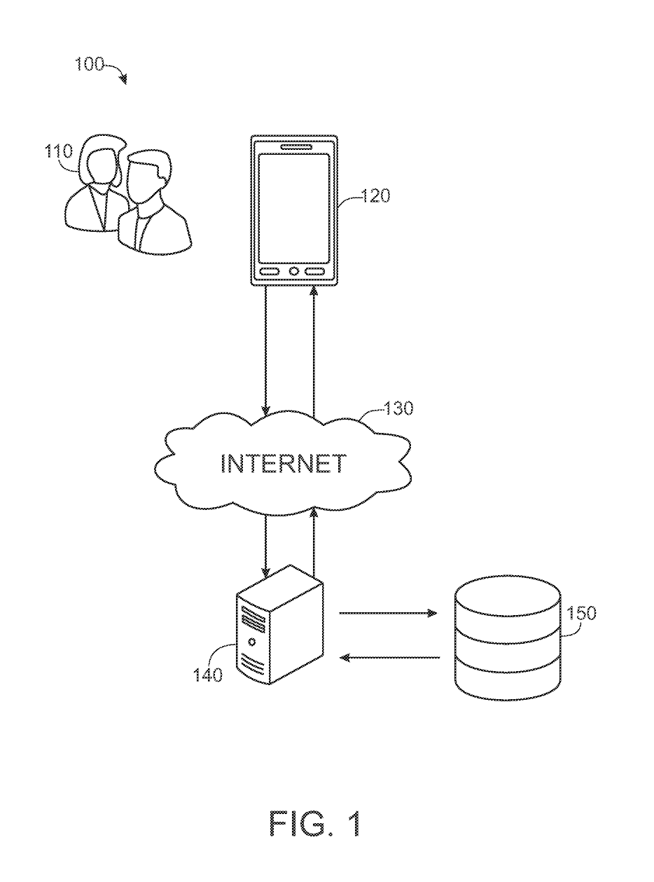

Referring to FIG. 1, there is shown a specified location and nearby area related crime information reporting system 100 comprising a user 110 and a user display device 120, such as but not limited to, mobile phone, smartphone, tablet, nettop, pda, laptop, palmtop and the like. The user display device 120 is using a wireless communication network 130 for communicating with a server 140 located at a secure location. The server 140 is further transmitting and receiving information, such as but not limited to, uniform crime reports by the Federal Bureau of Investigation (FBI) and by annual national crime victimization surveys by the Bureau of Justice Statistics from a crime information database 150 which is an already maintained and readily available crime information database of the FBI and the U.S. Justice Department and is from over 17,000 local law enforcement agencies in the US.

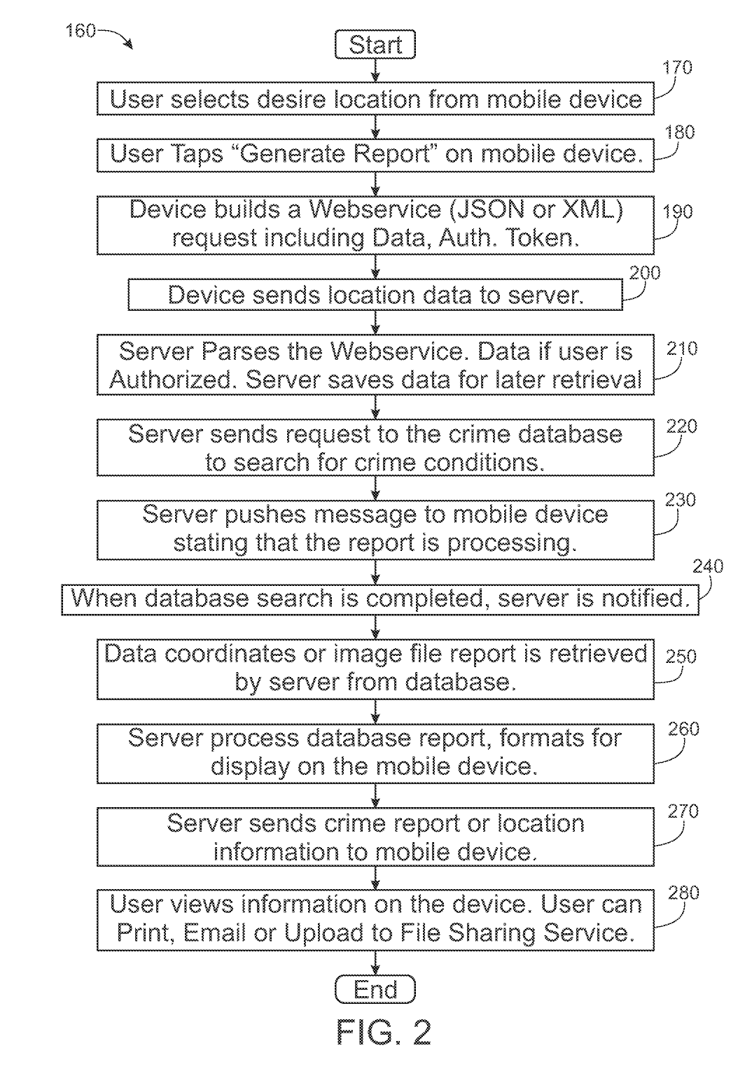

Referring to FIG. 2, there is shown a method 160 for using the system 100 for requesting specified location and nearby area related crime information reports. At block 170, the user 110 selects a desired location on the user display device 120. At block 180, the user 110 selects an option on the user display device 120 for generating specified location and nearby area related crime information report by pressing associated button on the user interface of the wireless user display device 120. At block 190, the user display device 120 creates a webservice request preferable in a JSON or XML format comprising the user 110 authentication or registration data token. At block 200, the user display device 120 transmits the webservice request to the server 140 through a wireless communication network 130. At block 210, the server 130 process the received webservice request and validate the authentication or registration token of the user 110 and if the user 110 is authorized for access then the server 140 saves the authentication data for future use so as to provide quick and efficient access to server 140. At block 220, the server 140 transmit received specified location and nearby area related crime information request from user display device 120 to the crime database 150 to search for the requested specified location and nearby area related crime information. At block 230, the server 140 send a message to the user display device 110 stating that the requested crime information report is processing. At block 240, the crime database 150 transmits the extracted specified location and nearby area related crime information to server 140 in the form of a notification message. At block 250, the server 140 retrieves the data coordinate or the image file as transmitted by the crime database 150. At block 260, the server 140 further processes the received information into the file format acceptable by the user display device 110. At block 270, the server 140 transmits the processed information to the user display device 110 for displaying on the user display device 120. At block 280, the user 110 review the transmitted information on the user display device 120 which further enables the user 110 for printing sharing or uploading the displayed specified location and nearby area related crime information on various social or file sharing sources.

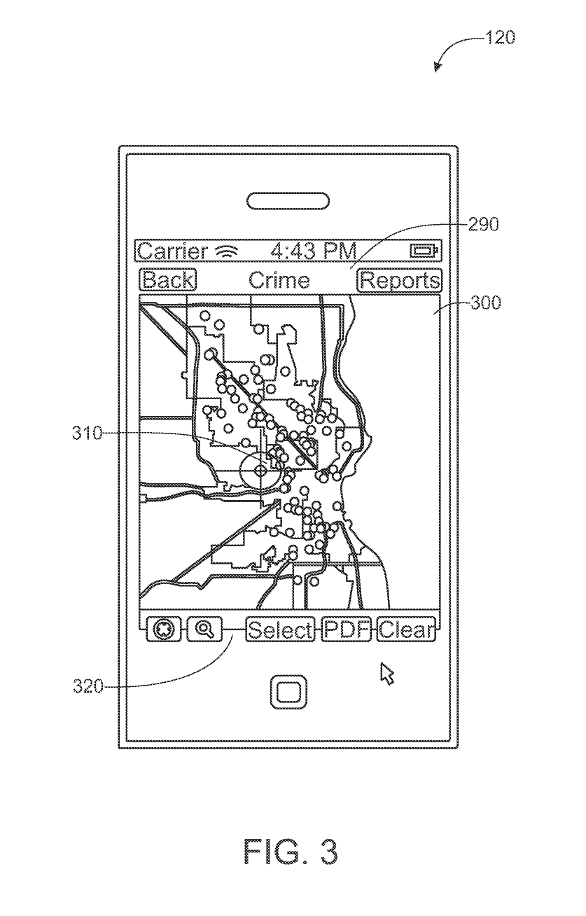

Referring to FIG. 3, there is shown the user interface 290 of the wireless user display device 120 for displaying the requested specified location and nearby area related crime information in an easy to read format as created by the server 140; a map display 300 which creates an easy to read information for displaying on the user display device 120; a location indicator 310 which helps in selecting and reading the user 110 specific location on the display of the user display device 120; a selection toolbar 320 which provides selection options to the user 110 for performing various actions for generating and saving the requested location related crime information.

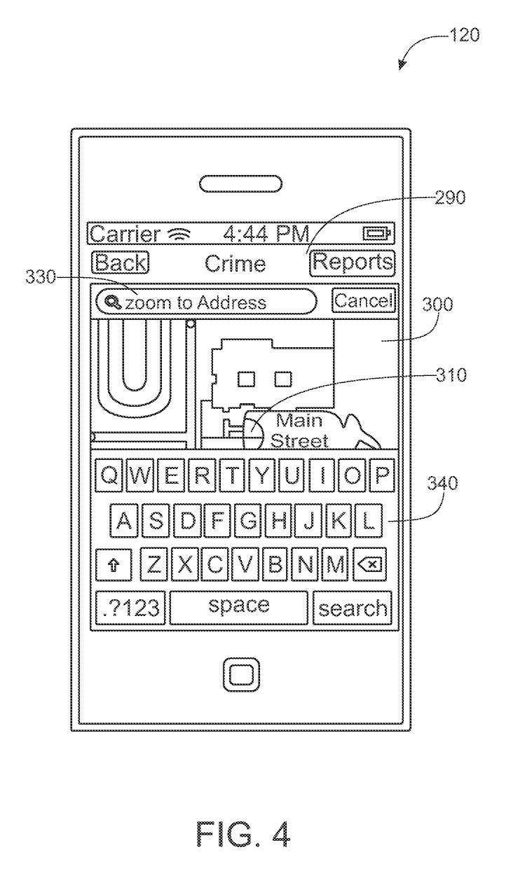

FIG. 4 shows another preferred embodiment of the present invention for inputting the user 110 specific location request for identifying specified location and nearby area related crime information in or around the specified location by the user 110 using the display device 120. The information display interface 290 also provides an input keypad 340 which is generally used in current wireless communication devices for inputting user 110 specific instructions manually. An address box 330 displays the inputted location request for user review and final selection before transmitting the request to the server 140.

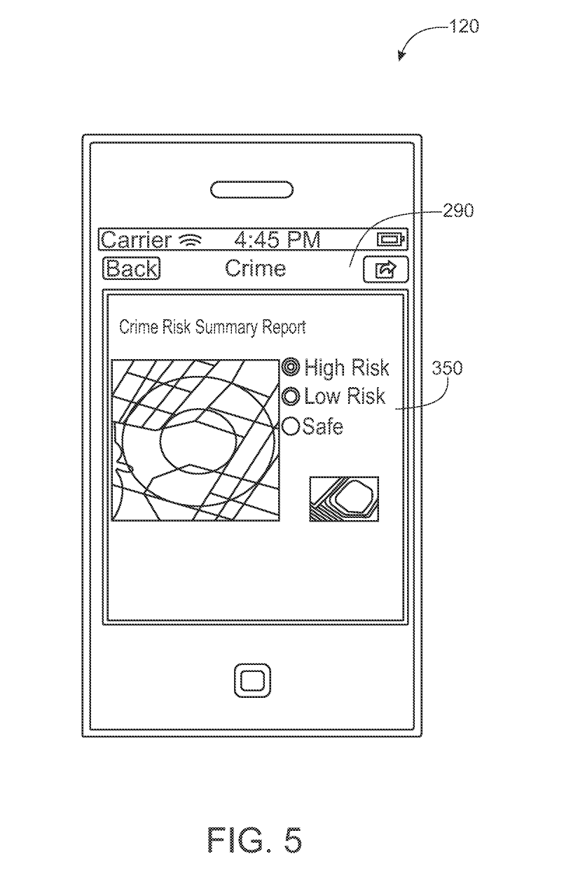

FIG. 5 shows the user display device 120 displaying the specified location and nearby area related crime information report 350 to the user 110.

In a preferred embodiment of the present invention there is provided a system and method for identification and presentation of the specified location and nearby area related crime information comprising the user 110 using the user display device 110, such as but not limited to, mobile phone, Smartphone, tablet, nettop, GPS devices, PDA, Laptop, Palmtop for inputting a desired location either by using the global positioning system of the display device 120 which associates the device location automatically or by entering the location information manually by using the keypad 340 of the user display device 120 for creating the webservice request for accessing the server 140. The selections of the specified location and nearby area on the wireless user display device 110 include identification and selection of the location name along with the associated geographic coordinates. The server 140 receives the specified location and nearby area related crime information request from the user display device 120 and then transmits the received specified location and nearby area related crime information request to the crime information database 150. The user display device 120, the server 140 and the crime information database 150 uses a wireless communication network 130 for transmitting and receiving information. The webservice access request comprises the user 110 registration information preferable in the JSON or XML format which is transmitted to the server 140 for validating the access for requesting and receiving specified location and nearby area related crime information. The server 140 stores the received authorized user information for future use. The server 140 notifies the wireless user device 120 that the requested information is processing. The location specific crime information database 150 notifies the server 140 that the requested information has been identified and the server 140 then retrieves the data coordinates or image information from the location specific crime information database 150. The server 140 then processes the retrieved information and creates the specified location and nearby area related crime report in the user display device 120 readable format. The server 140 then transmits the processed information to the user display device 120. The user display device 120 displays the transmitted information in a easy to read format, such as but not limited to, maps, graphs or the like which can further be shared, printed, uploaded or email to other users inside or outside the user contacts.

Although the present invention has been described in detail with reference to certain examples thereof, it may be also embodied in other specific forms without departing from the essential spirit or attributes thereof. For example, the user wireless display device 120 described with reference FIGS. 3-5 may be a smartphone that allows the user 110 to enter an electronic mail address via the keypad 340 so that the location specific information can be electronically delivered. Embodiments may also allow the customer 110 to enter a postal address should the user 110 wish to receive a high-quality print of the images.

In addition, some embodiments of the present invention may be integrated with crime information website or video broadcast system. That is, many crime information websites already utilize a plurality of cameras and camera operators to provide live video broadcasts of crimes and crime information live display. These systems are designed to capture unpredictable live changes in the crime information. The present invention can take advantage of this pre-existing crime information databases and labor investment to provide information to the user 110. These images may be highly desirable because the unpredictable changes in the crime information make it difficult for the user 110 to actually analyze and read the safety of a specific location.

The present invention and components thereof are also capable of being distributed as a program product in a variety of forms, and applies equally regardless of the particular type of user display device being used to actually carry out the location crime information distribution.

The accompanying figures and this description depicted and described embodiments of the present invention, and features and components thereof. Accordingly, it is desired that the embodiments described herein be considered in all respects as illustrative, not restrictive, and that reference be made to the appended claims for determining the scope of the invention.

We claim:

1. A specified location and nearby area crime reporting system, comprising:
a wireless user display device, wherein the wireless user display device communicates user location through a location reporting means or by manually entering the location using keyboard of the wireless user display device;
a server in communication with the wireless user display device using a wireless communication network, wherein access to said server is validated by a webservice request generated by the wireless user display device;
a crime database containing location specific crime information which is in communication with the server through a wired or wireless communication network for receiving location specific request from the server and transmitting the requested specified location and nearby area specific crime information to the server, wherein the server further processes the transmitted specified location and nearby area crime report for generating a wireless user display device acceptable file format and then transmitting the generated specified location and nearby area specific crime information report to the wireless user display device; and
an user interface enabling user to share generated specified location and nearby area related crime report through the wireless communication network.

2. The system of claim 1, wherein said wireless user display device includes mobile phone, smartphone, tablet, nettop, pda, laptop, palmtop and the like.

3. The system of claim 1, wherein the location reporting means includes a global positioning system.

4. The system of claim 1, wherein said webservice request is created in the JSON or XML format.

5. The system of claim 1, wherein said crime database includes databases maintained by the FBI and the United States Justice Department and is from local law enforcement agencies in the United States.

6. The system of claim 1, wherein said transmitted report comprises uniform crime reports by the Federal Bureau of Investigation (FBI) and by annual national crime victimization surveys by the Bureau of Justice Statistics.

7. The system of claim 1, wherein said transmitted report is created in the JSON, HTML, PDF or XML format.

8. A method for specified location and nearby area related crime reporting, comprising:
selecting a specified location and nearby area using a wireless user display device;
selecting an option on the wireless user display device for generating a report on specified location and nearby area crime;
generating a webservice request comprising user authentication data;
sending webservice request to a server;
saving the webservice data on server for future requests;
sending the crime report generation request to a crime database;
transmitting the generated report to the server;
processing transmitted report by the server for generating wireless user display ready report format; and
providing user selection options on the wireless user display device for sharing the generated report through wireless communication network.

9. The method of claim 8, wherein said wireless user display device includes mobile phone, smartphone, tablet, nettop, PDA, laptop, palmtop and the like.

10. The method of claim 8, wherein selecting a specified location and nearby area on the wireless user display device includes identifying and selecting the location name along with the associated geographic coordinates.

11. The method of claim 8, wherein selecting a specified location and nearby area on the wireless user display device includes location reporting by a global positioning system of the user's wireless display device.

12. The method of claim 8, wherein said selection of specified location and nearby area on the wireless user display device is automatically associated with the device location.

13. The method of claim 8, wherein said selection of specified location and nearby area on the wireless user display device includes location input by using device keypad.

14. The method of claim 8, wherein selecting an option on the wireless user display device for generating the report on specified location and nearby area cime includes pressing associated button on the wireless user display device.

15. The method of claim 8, wherein said webservice request is created in the JSON or XML format.

16. The method of claim 8, wherein said transmitted report comprises uniform crime reports by the Federal Bureau of Investigation (FBI) and by annual national crime victimization surveys by the Bureau of Justice Statistics.

17. The method of claim 8, wherein said crime database contains location information related to plurality of geographic locations.

18. The method of claim 8, wherein said transmitted report is created in the JSON or XML format.
